(19) United States
(12) Patent Application Publication
(10) Pub. No.: US 2014/0183883 A1
(43) Pub. Date: Jul. 3, 2014

(54) DOOR STOP

(71) Applicant: Michael R. Millsap, Mililani, HI (US)

(72) Inventor: Michael R. Millsap, Mililani, HI (US)

(21) Appl. No.: 13/733,489

(22) Filed: Jan. 3, 2013

(51) Int. Cl. E05C 17/54

(52) U.S. Cl. CPC E05C 17/54
USPC 292/288

(57) ABSTRACT

A door stop including a block having a top surface and a bottom surface. The block includes an engaging perimeter that is substantially orthogonal to each of the top surface and the bottom surface. The block includes a non-engaging perimeter opposite the engaging perimeter and disposed between the top surface and the bottom surface. The block includes a protrusion extending therefrom at a boundary region that is between the engaging perimeter and the non-engaging perimeter. The door stop includes a first selectably swivelable and selectably rotatable hook extending from the top surface near the engaging perimeter.

### BACKGROUND OF THE INVENTION

1. Field of the Invention

The present invention relates to door stops, specifically to a door stop configured to hold a door in an open position.

2. Description of the Related Art

A doorstop, or a door stopper or a door stop, is an object or device used to hold a door open or closed, or to prevent a door from opening too widely. Alternatively, a doorstop can be a thin slat built inside a door frame to prevent a door from swinging through when closed.

A door may be stopped by a door stop which is simply a heavy solid object, such as a rubber, placed in the path of the door. These stops are predominantly improvised. Historically, lead bricks have been popular choices when available. However, as the toxic nature of lead has been revealed, this use has been strongly discouraged.

Another method is to use a door stop which is a small wedge of wood, rubber, plastic, cotton or another material. Manufactured wedges of these materials are commonly available. The wedge is kicked into position and the downward force of the door, now jammed upwards onto the doorstop, provides enough static friction to keep it motionless.

Another strategy is to equip the door itself with a stopping mechanism. In this case, a short metal bar capped with rubber, or another high friction material, is attached to a hinge near the bottom of the door opposite the door hinge and on the side of the door which is in the direction that it closes. When the door is to be kept open, the bar is swung down so that the rubber end touches the floor. In this configuration, further movement of the door towards being closed increases the force on the rubber end, thereby increasing the frictional force which opposes the movement. When the door is to be closed, the stop is released by pushing the door slightly more open which releases the stop and allows it to be flipped upwards. A newer version of equipping the door with the stopping mechanism is to attach a magnet to the bottom of the door on the side which opens outward which then latches onto another magnet or magnetic material on the wall or a small hub on the floor. The magnet must be strong enough to hold the weight of the door, but weak enough to be easily detached from the wall or hub.

Some improvements have been made in the field. Examples of references related to the present invention are described below in their own words, and the supporting teachings of each reference are incorporated by reference herein:

U.S. Pat. No. 7,904,992, issued to Agster et al., discloses a door stop device comprising a block member, a receiving channel to facilitate placement of the device onto a door hinge, and an attaching means suitable for removably attaching the door stop device to an item of clothing worn by a user. The door prop device of the present invention is designed to be readily accessible and available for immediate use by those who primarily work in, or provide service to, the resort, hotel and motel industries.

U.S. Pat. No. 5,044,681, issued to Neighbors, discloses a door stop arrangement is directed between a door frame and a door for positioning upon a hinge to effect maintaining the door in an opened configuration. The door stop includes a “V” shaped body defined by a joinder line, with the “V” shaped body including an “L” shaped handle extending rearwardly of the body bisecting an acute included angle between the plates defining the body to permit positioning of the “L” shaped handle overlying the hinge when the plates are directed between the door and door frame.

U.S. Pat. No. 5,027,471, issued to Barnes, discloses a door prop device for the purpose of maintaining a hinged door in a propped-open position against the forces of spring tension, wind, gravity, or other causes, which will effectively function without damaging either the door or any adjacent structure and which will function on doors which pivot on vertical axes, horizontal axes, or any pivot axes orientations between vertical and horizontal. The device comprises a block-shaped prop member and a retainer member attached to the prop member. The retainer member is adapted to be placed over and engage with a hinge pin of an opened door hinge whereby the prop member is caused to assume an obstructing position in the space between the separated plates of the opened hinge. When it is desired to close the door, the door prop device is simply removed from the hinge and the door may then be closed.

U.S. Pat. No. 6,149,212, issued to Kuntz et al., discloses an adjustable door stop that enables a hinged door to be propped open at any desired angle relative to the frame to which the door is mounted. Alternatively, the device enables a door to be securely closed, thereby operating as a lock. The device comprises a substantially cylinder-like structure placed over or otherwise mounted to a door hinge. An arcuate inner chamber is disposed and freely moves within the substantially hollow interior of an arcuate outer chamber. Various angular orientations are obtained by selectively aligning the inner chamber with the outer chamber. The chambers are held in their respective positions by activating a locking member disposed on the door stop.

U.S. Pat. No. 6,003,911, issued to Sowash, discloses a door stop comprising a stop block. One of the surfaces of the stop block has an angular recess therein with angular faces positioned at an acute angle with respect to the stop block surfaces. The stop block is configured to insert into the jamb when the door is opened and the angular faces engaged over the top corner of the hinge edge stile of the door to hold the door open. A handle is attached to the stop block so that it may be easily inserted and removed.

The inventions heretofore known suffer from a number of disadvantages which include being limited in use, being difficult to use, being difficult to hold in place, being complex to use, being damaging to the door, being expensive, being ineffective, being inefficient, being bulky, requiring the user to bend over to use, failing to keep a door open, slipping/sliding/shifting during use, being bulky, having sharp/jagged/pointed protrusions, not being versatile, being weak, and not having a compact mode for storage.

What is needed is a door stop that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available door stops. Accordingly, the present invention has been developed to provide a safe and efficient door stop.

According to one embodiment of the invention, there is a door stop that may include a block. The block may include a top surface and a bottom surface. The block may include an engaging perimeter that may be substantially orthogonal to each of the top surface and the bottom surface and may be disposed therebetween. The block may include a non-engaging perimeter opposite the engaging perimeter and may be disposed between the top surface and the bottom surface. The block may include a protrusion that may be extending therefrom at a boundary region that may be between the engaging perimeter and the non-engaging perimeter.

The door stop may include an engagement layer that may be coupled to an exterior of the engaging perimeter. The engagement layer may have an outer surface that may have a higher coefficient of friction than an outer surface of the block. The engagement perimeter may include two substantially parallel surfaces that may be connected by a surface that may be substantially orthogonal to each.

The door stop may include a first selectably swivelable and selectably rotatable hook that may be extending from the top surface near the engaging perimeter. The top surface may include a cavity near the first hook and may be sized and shaped to receive the first hook when the first hook is in a stowed mode. The door stop may include a second selectably swivelable and selectably rotatable hook that may be extending from the bottom surface near the engaging perimeter.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a perspective view of a door stop, according to one embodiment of the invention;

FIG. 2 is a perspective view of a door stop in use, according to one embodiment of the invention;

FIG. 3 is a perspective view of a door stop, according to one embodiment of the invention;

FIG. 4 is a front elevational view of a door stop, according to one embodiment of the invention; and

FIG. 5 is a side elevational view of a plurality of door stop design configurations, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

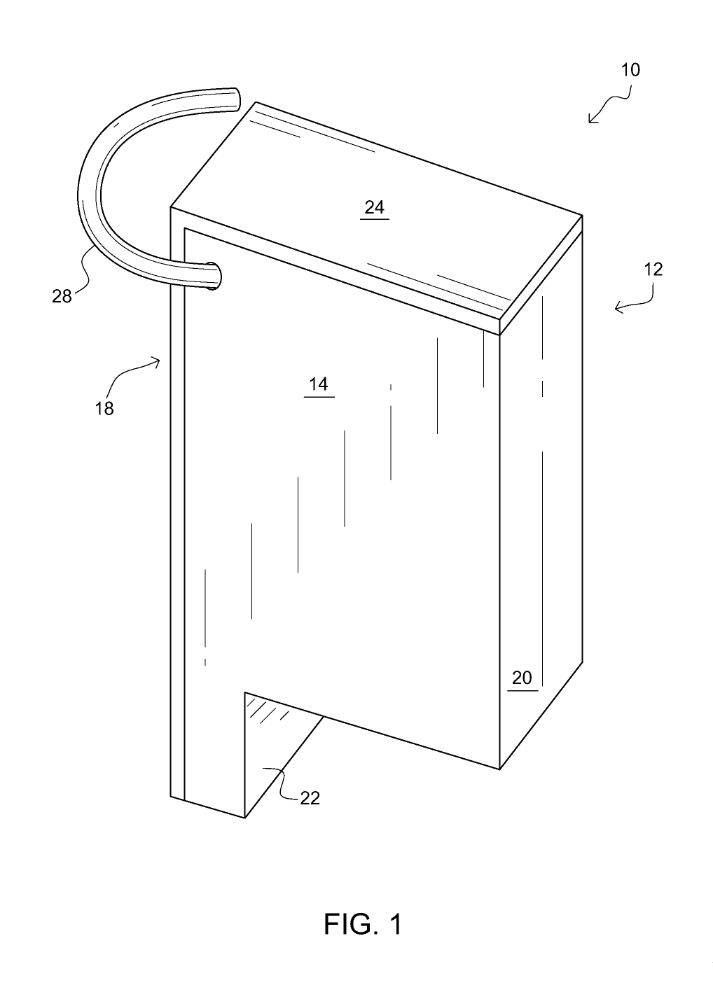

FIG. 1 is a perspective view of a door stop, according to one embodiment of the invention. There is shown a door stop 10 including a block 12

The illustrated door stop 10 is configured to support and hold a door in an open position. The door stop 10 includes a block 12 having a top surface 14 and a bottom surface, disposed on an opposite side of the top surface 14. The block 12 includes an engaging perimeter 18 that is substantially orthogonal to each of the top surface 14 and the bottom surface and disposed therebetween. The engaging perimeter 18 is configured to engage a door and a door frame, thereby supporting and holding a door in an open position. The block 12 includes a non-engaging perimeter 20 opposite the engaging perimeter 18 and is disposed between the top surface 14 and the bottom surface. The non-engaging perimeter 20 is configured to not to engage a door or a door frame while the door stop 10 is supporting and holding a door in an open position. The block 12 includes a protrusion 22 extending therefrom at a boundary region that is between the engaging perimeter 18 and the non-engaging perimeter 20.

The door stop 10 includes an engagement layer 24 coupled to an exterior of the engaging perimeter. The engagement layer 24 includes an outer surface having a higher coefficient of friction than an outer surface of the block 12. The engagement perimeter 18 includes two substantially parallel surfaces connected by a surface that is substantially orthogonal to each.

The illustrated engagement layer 24 may include a layer of material having a higher effective coefficient of friction than the rest of the block. Such a layer may include one or more of the following materials in one or more layers: rubber, high friction plastic, adhesive, gecko-like material (nested nanotubes, generally carbon) such as but not limited to the product known as Geckskin created by the University of Massachusetts Amherst, polydimethylsiloxane (PDMS), satae (bristles that increase grip), silicone, magnets, and/or “stealth rubber” produced by Five Ten USA of Redlands Calif. and Stealth Rubber of Redlands Calif. The illustrated engagement layer 24 may extend fully or partially along one or more of the illustrated surfaces of the block that contact the hinge and/or the door, including but not limited to the protrusion 22.

The illustrated door stop 10 includes a first selectably swivelable and selectably rotatable hook 28 extending from the top surface 14 near the engaging perimeter 18. The first selectably swivelable and selectably rotatable hook 28 is configured to secure about a hinge of a door, thereby securing the door stop 10 in between a door and a door frame. While the illustrated hook has a circular cross-section, the hook may have a flattened cross-section instead for more compact storage of the same. The illustrated hook is made of an inelastically deformable material (e.g. metal wire: copper, lead, tin, etc. and composites thereof) that permits the hook to be bent and rotated. The illustrated hook may include a region near the block that is inelastically deformable while the curved hook region is more rigid, thereby keeping its hook shape while under stress. The illustrated hook extends into the block, thereby anchoring the hook thereto.

In one embodiment, there is a door stop that operates on the hinge instead of on the frame of the door so that it doesn't damage the door and so that people don't have to bend down to use it. It may include a generally square block that might be plastic. There is soft plastic/rubber or otherwise friction enhancing strip to keep the block from slipping on the metal of the hinge. The strip works like the sole of a sport shoes to give the block grip and cushion. There may be one or more hooks that can pivot/rotate/open kind of like a butterfly wing and that fold up in a compact manner. The hooks may both rotate and pivot, thereby permitting them to be stored flat against the block but also to extend away from and over the edge of the block when deployed. The hooks may be of an inelastically deformable material and/or may include paired rotating joints that permit two degrees of rotational freedom for the hook. There may be one or more magnets, suction cups, or the like about the perimeter of the block that may advantageously assist in coupling the block to a hinge/door.

In operation, the user opens the door and stands near the interior angle of the hinge of the door (the interior angle is the smaller angle when the door is opened a small amount). The user opens the door sufficiently to allow the block member of the door stop to be wedged into the interior angle of the hinge, adjacent to and abutting both of the hinge plates of the hinge. The longer side of the block is generally abutting the hinge plate that is coupled to the door, while the shorter side is generally placed abutting the hinge plate coupled to the door frame. The hook is deployed and placed about the top middle region of the hinge, thereby hooking over the hinge pin area of the hinge, wherein gravity causes the hook to remain in place vertically and hold the block in place in the region of the hinge. The door is allowed to close up against the block and the friction enhancing strip of the block grips the hinge plate coupled to the door to keep the block in place, laterally. Thus positioned, the door stop prevents further closing of the door, reduces the amount of “give” that door stops typically allow in doors by friction fitting to the same, and applying pressure against the hinge of the door, instead of directly to the door. When removed, the hook(s) may be returned to a compact mode wherein the door stop may be conveniently stored in the user's pocket without undesirable protrusions that might damage the pocket and without taking up extra space.

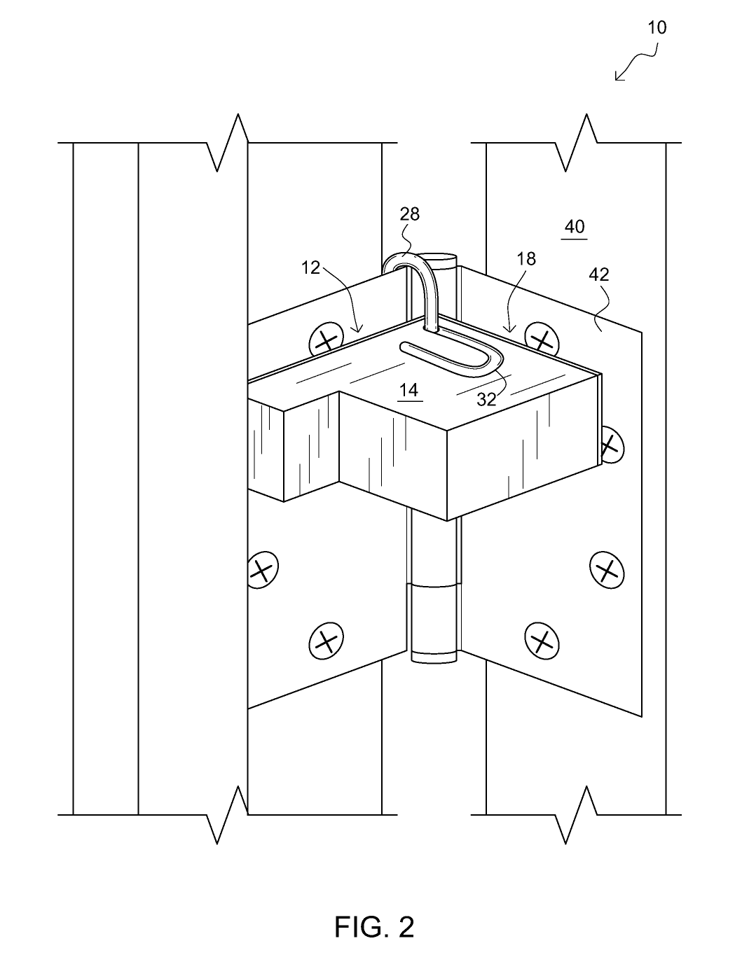

FIG. 2 is a perspective view of a door stop in use, according to one embodiment of the invention. There is shown a door stop 10 disposed between a door 40 and a door frame 90 including a block 12 having a selectably swivelable and selectably rotatable hook 28 secured to a hinge 42.

The illustrated door stop 10 is configured to hold a door in an open position. The door stop 10 includes a block 12 having a top surface 14 and a bottom surface. The block includes an engaging perimeter that is substantially orthogonal to each of the top surface 14 and the bottom surface and is disposed therebetween. The illustrated engaging perimeter 18 is configured to engage an interior of a hinge 42 that is coupling a door 40 and a door frame 90. The engaging perimeter 18 is configured to engage both sides of the interior of the hinge 42. The engaging perimeter 18 is configured to rest up against the interior of the hinge 42, thereby supporting and holding the door 40 in an open position.

The illustrated door stop 10 includes a first selectably swivelable and selectably rotatable hook 28 extending from the top surface 14 near the engaging perimeter 18. The top surface 14 includes a cavity 32 near the first hook 28 and is sized and shaped to receive the first hook 28 when the first hook 28 is in a stowed mode. The illustrated cavity is a curved trench in the block body that is shaped, positioned, and sized to receive the hook when in a stowed mode, thereby permitting the hook to lay flush with the surface of the block, thereby minimizing the compact storage size of the device.

In operation of one embodiment of the invention, there is a door opened to dispose an interior of a door hinge. A user places the door stop into a door frame, wherein an engaging perimeter rests up against an interior side of the door hinge. The engaging perimeter is in contact with both the interior of the door hinge, and also with the interior of the door frame hinge. The user disposes a selectably swivelable and selectably rotatable hook from a cavity of a top surface of the door stop. The user rotates the hook up over the hinge and secures the door stop in place. The user releases the door and the door is supported and held in place by the door stop.

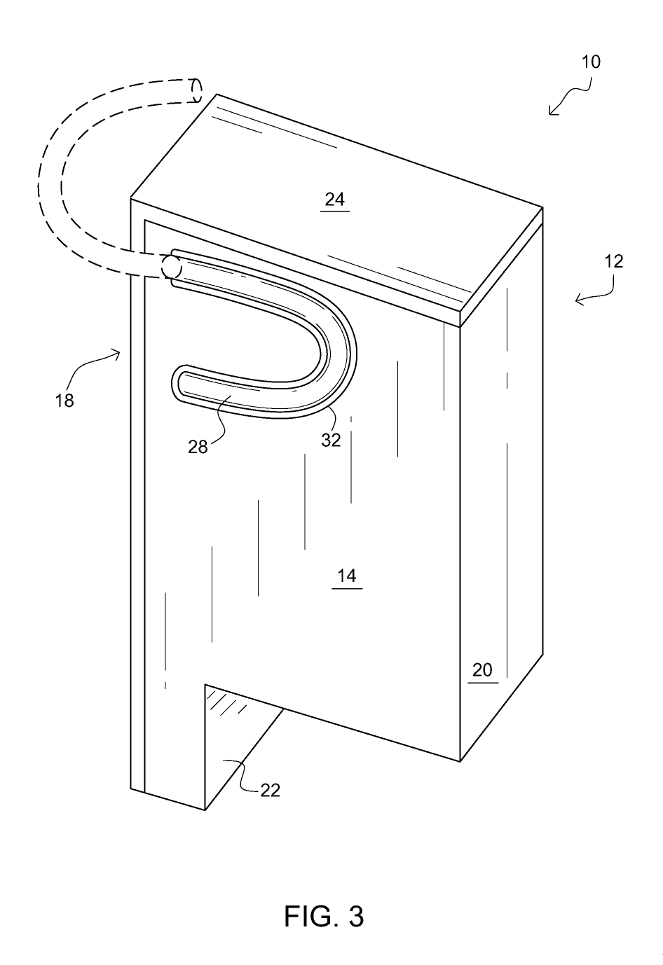

FIG. 3 is a perspective view of a door stop, according to one embodiment of the invention. There is shown a door stop 10 including a block 12 having a top surface 14 including a cavity 32 with a hook 28 stored therein.

The illustrated door stop 10 is configured to hold a door in an open position. The door stop 10 includes a block 12 having a top surface 14 and a bottom surface. The block 12 includes an engaging perimeter 18 that is substantially orthogonal to each of the top surface 14 and the bottom surface and is disposed therebetween. The block 12 includes a non-engaging perimeter 20 opposite the engaging perimeter 18 and is disposed between the top surface 14 and the bottom surface. The block 12 includes a protrusion 22 extending therefrom at a boundary region that is between the engaging perimeter 18 and the non-engaging perimeter 20.

The door stop 10 includes an engagement layer 24 coupled to an exterior of the engaging perimeter 18. The engagement layer 24 having an outer surface that includes a higher coefficient of friction than an outer surface of the block 12. The engagement perimeter 18 includes two substantially parallel surfaces that are connected by a surface that is substantially orthogonal to each.

The door stop 10 includes a first selectably swivelable and selectably rotatable hook 28 extending from the top surface 14 near the engaging perimeter 18. The top surface 14 includes a cavity 32 near the first hook 28 and sized and shaped to receive the first hook 28 when the first hook 28 is in a stowed mode, as illustrated.

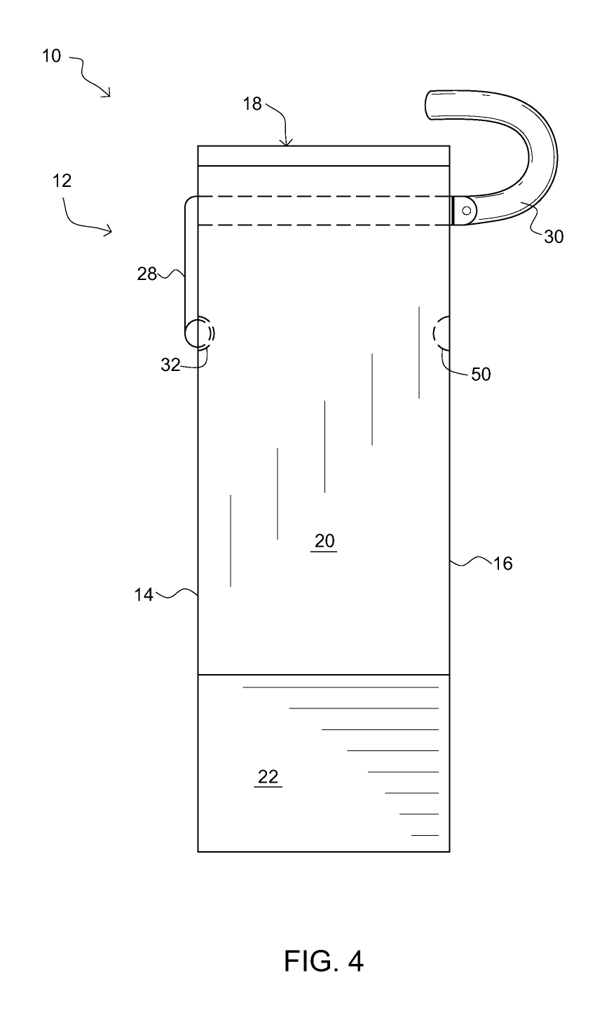

FIG. 4 is a front elevational view of a door stop, according to one embodiment of the invention. There is shown a door stop 10 including a first selectably swivelable and selectably rotatable hook 28 in a compact mode stored in a cavity and a second selectably swivelable and selectable rotatable hook 30 in a deployed mode.

The illustrated door stop 10 includes a block 12 having a top surface 14 and a bottom surface 16. The block 12 includes an engaging perimeter 18 that is substantially orthogonal to each of the top surface 14 and the bottom surface 16 and is disposed therebetween. The block 12 includes a non-engaging perimeter 20 opposite of an engaging perimeter and is disposed between the top surface 14 and the bottom surface 16. The block 12 includes a protrusion 22 extending therefrom at a boundary region that is between the engaging perimeter and the non-engaging perimeter 20.

The door stop 10 includes a first selectably swivelable and selectably rotatable hook 28 extending from the top surface 14 near the engaging perimeter 18. The top surface 14 includes a cavity 32 near the first hook 28 and is sized and shaped to receive the first hook 28 when the first hook 28 is in a stowed mode. The illustrated door stop 10 includes a second selectably swivelable and selectably rotatable hook 30 extending from the bottom surface 16 near the engaging perimeter 18. The bottom surface 16 includes a cavity 50 near the second hook 30 and is sized and shaped to receive the second hook 30 when the second hook 30 is in a stowed mode. The illustrated hooks 28 and 30 are a single structure that extends through a channel through the body of the block (see the dotted lines therebetween). In one non-limiting embodiment, the hook structure is a single wire with curved ends that extends through a hole in the block.

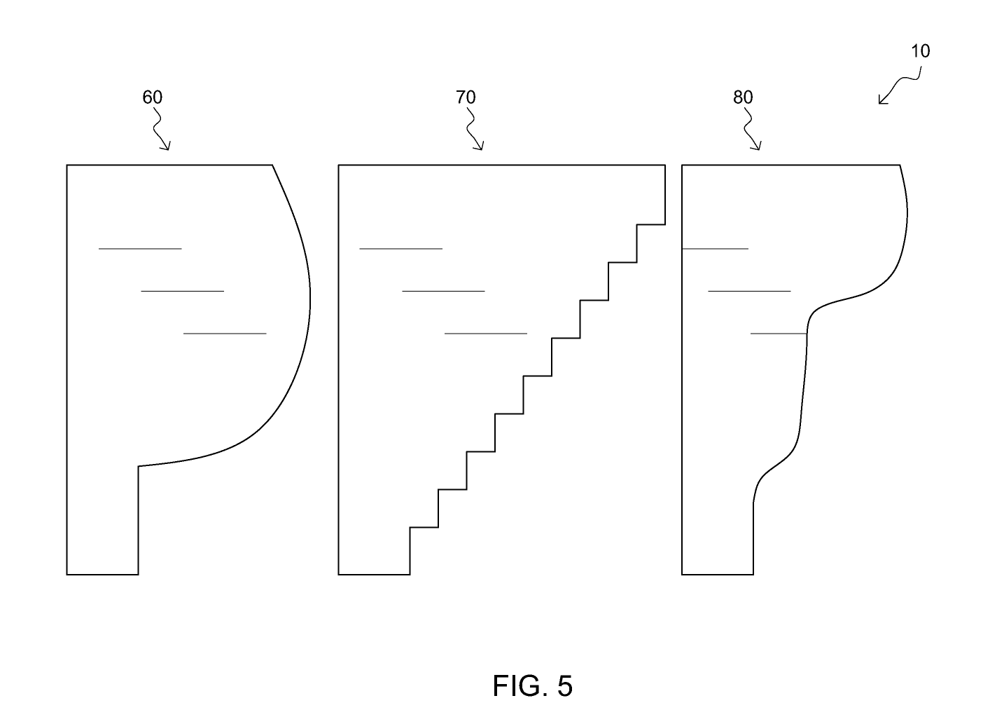

FIG. 5 is a side elevational view of a plurality of door stop design configurations, according to one embodiment of the invention. There is shown a plurality of door stop design configurations wherein the non-engaging perimeter is of varying shapes.

The illustrated door stops 10 are configured to support and hold a door in an open position. The illustrated door stops 10 each include an engaging perimeter that are substantially similar. The illustrated door stops 10 each include different non-engaging perimeters that vary in design configurations, but are still configured to perform its intended function.

The illustrated door stops 10 include a semi-circular design configuration 60 configured to provide a rounded profile design configuration but is still configured to perform its intended function.

The illustrated door stops 10 include a stepped design configuration 70 configured to provide a stair step profile design configuration but is still configured to perform its intended function.

The illustrated door stops 10 include an oblong design configuration 80 configured to provide an irregular curve profile design configuration but still configured to perform its intended function.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate a particular thickness of the block, it is understood that the thickness of the block may vary for aesthetic and/or utilitarian purposes.

Additionally, although the figures illustrate particular shapes of the block, it is understood that the usable shapes are plethoric and may include regions that are rectangular, oval, circular, elliptical, irregular, polygonal, and the like and combinations thereof.

It is also envisioned that the illustrated hooks may include various structures that permit positioning and storage of the same according to the description included herein and that the specific structures that permit such operation are plethoric, including but not limited to rotating joints, twistable regions, elastic deformability of the hook material, ball-socket joints, swivels, hinge joints, condyloid joints, saddle joints, rotary joints, rotating unions, and the like and combinations thereof, including paired or adjacent structures that together permit rotational motion in more than one degree of freedom.

It is expected that there could be numerous variations of the aesthetic design of this invention.

Finally, it is envisioned that the components of the device may be constructed of a variety of materials including but not limited to rubber, plastic, metal, wood, fibers, woven fibers, polymers, resins, ceramics, and the like and combinations thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A door stop comprising:
a) a block, including:
a1) a top surface;
a2) a bottom surface;
a3) an engaging perimeter substantially orthogonal to each of the top surface and the bottom surface and disposed therebetween; and
a4) a non-engaging perimeter opposite the engaging perimeter and disposed between the top surface and the bottom surface; wherein the block includes a protrusion extending therefrom at a boundary region between the engaging perimeter and the non-engaging perimeter;
b) an engagement layer coupled to an exterior of the engaging perimeter; and
c) a first selectably swivelable and selectably rotatable hook extending from the top surface near the engaging perimeter.

2. The door stop of claim 1, further comprising a second selectably swivelable and selectably rotatable hook extending from the bottom surface near the engaging perimeter.

3. The door stop of claim 1, wherein the top surface includes a cavity near the first hook and sized and shaped to receive the first hook when the first hook is in a stowed mode.

4. The door stop of claim 1, wherein the engagement layer has an outer surface having a higher coefficient of friction than an outer surface of the block.

5. The door stop of claim 1, wherein the engagement perimeter includes two substantially parallel surfaces connected by a surface that is substantially orthogonal to each.

6. A door stop comprising:
a) a block, including:
a1) a top surface;
a2) a bottom surface;
a3) an engaging perimeter substantially orthogonal to each of the top surface and the bottom surface and disposed therebetween; and
a4) a non-engaging perimeter opposite the engaging perimeter and disposed between the top surface and the bottom surface;
b) an engagement layer coupled to an exterior of the engaging perimeter; and
c) a first selectably swivelable and selectably rotatable hook extending from the top surface near the engaging perimeter.

7. The door stop of claim 6, wherein the block includes a protrusion extending therefrom at a boundary region between the engaging perimeter and the non-engaging perimeter.

8. The door stop of claim 7, further comprising a second selectably swivelable and selectably rotatable hook extending from the bottom surface near the engaging perimeter.

9. The door stop of claim 8, wherein the top surface includes a cavity near the first hook and sized and shaped to receive the first hook when the first hook in a stowed mode.

10. The door stop of claim 9, wherein the engagement layer has an outer surface having a higher coefficient of friction than an outer surface of the block.

11. The door stop of claim 10, wherein the engagement perimeter includes two substantially parallel surfaces connected by a surface that is substantially orthogonal to each.

12. A door stop comprising:
a) a block, including:
a1) a top surface;
a2) a bottom surface;
a3) an engaging perimeter substantially orthogonal to each of the top surface and the bottom surface and disposed therebetween; and
a4) a non-engaging perimeter opposite the engaging perimeter and disposed between the top surface and the bottom surface; wherein the block includes a protrusion extending therefrom at a boundary region between the engaging perimeter and the non-engaging perimeter;
b) an engagement layer coupled to an exterior of the engaging perimeter; wherein the engagement layer has an outer surface having a higher coefficient of friction than an outer surface of the block; wherein the engagement perimeter includes two substantially parallel surfaces connected by a surface that is substantially orthogonal to each;
c) a first selectably swivelable and selectably rotatable hook extending from the top surface near the engaging perimeter; wherein the top surface includes a cavity near the first hook and sized and shaped to receive the first hook when the first hook in a stowed mode; and
d) a second selectably swivelable and selectably rotatable hook extending from the bottom surface near the engaging perimeter.
